(19) United States
(12) Patent Application Publication
(10) Pub. No.: US 2008/0255274 A1
(43) Pub. Date: Oct. 16, 2008

(54) Aqueous Ink Compositions with Improved Resistance

(75) Inventors: Andreas Wenning, Nottuln (DE); Dietmar Loest, Duelmen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/089,538

(22) PCT Filed: Oct. 13, 2006
(86) PCT No.: PCT/EP2006/067376

§ 371 Date: Apr. 8, 2008

(30) Foreign Application Priority Data
Oct. 20, 2005 (DE) 10 2005 050 268.7

(51) Int. Cl. C09D 11/10

(52) U.S. Cl. 524/27; 524/542; 524/431; 524/190; 524/88; 524/87; 524/325

(57) ABSTRACT

The invention relates to aqueous ink-jet ink compositions composed of a dispersant, a colorant, and, if desired, additives, possessing high water resistance, smear resistance and smudge resistance, and to their use for printing print media.

The invention relates to aqueous ink-jet ink compositions composed of a dispersant, a colorant, and, if desired, additives, having high water resistance, smear resistance and smudge resistance.

Inks used in ink-jet printers are generally inks of low viscosity that are based on water or organic solvents. A distinction is made between systems with continuous droplet flow (continuous ink jet, CIJ) and droplets on demand (drop on demand, DOD).

Barbiarz in his article “Fluid Dispensing in the Nineties” in Circuits Assembly, vol. 4 (1993), no. 8, pp. 34 to 36, describes how with continuous ink jets a continuous jet of ink flows through the nozzle and is excited by an ultrasonic transducer into forming droplets. As a result of the addition of salts to the ink the latter is weakly electrically conducting and can be deflected in an electrostatic field after a variable charge has been the case of applied. The droplet rate in continuous ink jet is, at 120 000 dps (drops per second), very high. Only a fifth of the droplets are charged. The uncharged droplets not used are collected and reutilized. In the case of drop on demand the ink is only ejected when substrate is actually to be printed. The exchange may take place, alternatively, piezoelectrically (piezo-jet), by formation of a vapor bubble (bubble-jet) or otherwise (impactjet). As Vest et al. describe in their article “Ink Jet Printing of Hybrid Circuits” in Proceedings IMS (ISHM-USA), 1983, pp. 261 to 267, the droplets in the case of piezo-jet are formed by means of shock waves from a piezoelectric transducer. The droplets are ejected from the aperture of the transducer at a rate of 5000 to 20 000 dps. A piezo-jet printhead can be used to print not only aqueous inks but also inks with organic solvents. In the case of bubble jet there is a hole drilled through the silicon platelet of the ink capillary, which is lined with a thin-film resistor. Current is briefly applied to this resistor, causing it to undergo sudden heating to 350° C. At the surface a vapor bubble is formed, which ejects the droplets. The silicon and the ink are cooled by the subsequent ink flow. This causes the vapor bubble to collapse. The droplet rate is 5000 dps. The bubble-jet system is restricted to aqueous inks. The impact-jet method, described by D. La in his article “A New Dispensing Technology: Dispensing-Jet Fluidshooting” in Proceedings Surface Mount International Conference and Exposition, Dallas, Tex., 1993, pp. 550 to 553, is a contactless dispensing method. The droplets are produced using what is called a solenoid (a kind of “hammer”). The droplet rate is 20 dps. In contrast to the other methods, the impact-jet method is able to process liquids of relatively high viscosity, at up to 300 Pa s.

Ink-jet inks are subdivided roughly into aqueous inks and nonaqueous inks. Aqueous inks generally contain water-soluble dyes, in solution in alcoholic solvents and water. Prints with aqueous inks have a general problem of poor water resistance. The requirement for ink-jet prints with improved quality also exists, however, when nonaqueous inks are used. Important attributes continually requiring improvement are better water resistance, greater smear resistance, including resistance to smearing with marker pens, and a higher stability toward wet and dry fingerprints.

EP 0 818 516 describes aqueous inks containing a water-insoluble dye, a dispersant, and water. The dispersant used comprises compounds which are able both to associate with the dye and to dissolve in water. These compounds, however, are not resins. Hence they do not themselves contribute to improving the water resistance, smearing resistance, and stability with respect to fingerprints.

EP 0 818 516 also describes, in its examples 1 to 3, the use of a noncrosslinking acrylate copolymer. This resin, however, is still water-sensitive even after drying, owing to its high acid number.

It was an object of the present invention, therefore, to find aqueous ink-jet inks possessing high and permanent resistance toward water, marker-pen smearing, and fingerprints.

The object on which the invention is based has surprisingly been achieved through the use of a combination of block-copolymeric polyalkylene oxides, containing styrene oxide, and ketone-aldehyde resins.

Surprisingly it has been found that the combination of block-copolymeric polyalkylene oxides, containing styrene oxide, with ketone-aldehyde resins is outstandingly suitable for use as a dispersant for aqueous ink-jet ink compositions.

The dried ink-jet ink compositions possess outstanding water resistance and smear resistance. Moreover, the aqueous ink-jet ink compositions are notable for high stability, and their prints for high gloss, high hardness, and excellent adhesion.

The invention provides aqueous inkjet ink compositions substantially containing
A) from 1% to 40% by weight of a dispersant composed of
   i) from 95% to 5% by weight of at least one block-copolymeric polyalkylene oxide containing styrene oxide, and
   ii) from 5% to 95% by weight of a ketone-aldehyde resin, and
   iii) from 0 to 80% by weight of at least one solvent, the sum of the amounts by weight of components i) to iii) being 100% by weight, and
B) from 1% to 70% by weight of at least one colorant, and
C) from 0 to 30% by weight of at least one auxiliary, and
D) from 10% to 98% by weight of water,
   the amount of the sum of components A), B), C) and D) being 100% by weight.

Since the combination of block-copolymeric polyalkylene oxides, containing styrene oxide, and ketone-aldehyde resins is soluble in water, it was completely surprising that it exhibits high smearing resistance and smudging resistance in aqueous ink-jet ink compositions.

Component A) is described in DE 10 2005 012 315.5. It preferably comprises aqueous or organic solvent-containing combinations of block-copolymeric polyalkylene oxides i), containing styrene oxide, of the general formula:

R¹O(SO)ₐ(EO)_{b}(PO)_{c}(BO)_{d}R²,
where R¹ is a straight-chain or branched or cycloaliphatic radical having from 8 to 13 carbon atoms,
R2=hydrogen, an aryl radical, alkyl radical or carboxylic acid radical having in each case from 1 to 8 carbon atoms,
SO=styrene oxide,
EO=ethylene oxide,
PO=propylene oxide,
BO=butylene oxide and
a=1 to 1.9,
b=3 to 50,
c=0 to 3,
d=0 to 3,
a, c or d being other than 0, and b>=a+c+d,
   and ketone-aldehyde resins ii), which are prepared preferably from cycloaliphatic ketones, aldehyde, and, if desired, further monomers. These ketone-aldehyde resins contain the following composition:
I. from 40% to 100 mol %, based on all ketones employed, of at least one alkyl-substituted cyclohexanone with one or more alkyl radicals having from 1 to 8 carbon atoms,
II. from 0.8 to 2.0 mol of at least one aliphatic aldehyde, based on 1 mol of all the ketones employed, and
   III. from 0 to 60 mol %, based on all ketones employed, of further ketones having aliphatic, cycloaliphatic, aromatic hydrocarbon radicals, it being possible for these to be identical or different and to be substituted in turn by the stated hydrocarbon radicals in the hydrocarbon chain, and also, if desired, phenols and/or urea or its derivatives.

The mixing ratio of the inventively used block-copolymeric polyalkylene oxides i) containing styrene oxide and the ketone-aldehyde resins ii) is from 95:5 to 5:95% by weight.

Pigments and/or dyes can be used as component B). Examples of pigments which can be used include organic or inorganic pigments and also carbon blacks.

Examples of inorganic pigments include titanium dioxides and iron oxides.

Examples of suitable organic pigments include azo pigments, metal complex pigments, anthraquinonoid pigments, phthalocyanine pigments, polycyclic pigments, particularly those of the thio indigo, quinacridone, dioxazine, pyrrolo, naphthalenetetracarboxylic acid, perylene, isoamidolin(on)e, flavanthrone, pyranthrone or isoviolanthrone series.

Carbon blacks which can be used include gas blacks, lamp blacks, and furnace blacks. These carbon blacks may have been additionally reoxidized and/or beaded.

As dyes which are soluble in the binder solutions used it is possible to employ all natural or synthetic organic dyes. The dyeings obtained using them possess optimum transparency. In contradistinction to pigments, it is possible to make full use of their color strength.

Natural dyes are animal dyes, such as carmine, kermes, lac dyes, Indian yellow, purple, sepia or gallstone, and vegetable dyes, such as indigo, alizarin dyes, flavonol dyes, dyes of the brasilin group, or color resins such as dragon's blood or gamboge.

Examples of synthetic dyes include basic dyes and color bases, acidic dyes and water-soluble metal complex dyes, alcohol- and ester-soluble dyes, and oil- and fat-soluble dyes.

In addition to a colorant it is also possible to use fillers additionally as component B). Fillers are usually substances in powder form which are virtually insoluble in the application medium. They are obtained predominantly from naturally occurring minerals by degradation, purification, grinding, and subsequent classification into particle-size fractions. Synthetic products as well, such as sulfates or carbonates, are used as fillers when, for example, purity (lightness) or particular fine division is important. Unlike pigments, fillers generally possess a low opacity. As well as increasing the volume (making the formulation cheaper), they display very specific effects in the film, such as reflection, surface structure, abrasion resistance or stone-chip resistance, for example. Their use is predetermined by their particle size, particle-size distribution, particle morphology, particle structure, hardness, density, color, wetability, abrasiveness, surface adsorption, refractive index, chemical composition, purity, stability, and price. Fillers are generally used additionally at from 0 to 95% by weight, based on the colorant.

Examples of fillers which can be dispersed in aqueous and/or solvent-containing ink compositions are those based on kaolin, talc, mica, other silicates, quartz, christobalite, wollastonite, perlites, diatomaceous earth, fibrous fillers, aluminum hydroxide, barium sulfate or calcium carbonate.

As component C) it is possible to use all of the auxiliaries known to the skilled worker for ink-jet ink compositions. These include, for example, defoamers, devolatilizers, Theological assistants, surface additives, which influence lubricity, scratch resistance, antiblocking, flow, and gloss, for example, substrate wetting additives, colloids with high molecular weight such as mannuronic acid, carob-bean flour, xanthan gum, dextran, chitosan, carboxymethylcellulose or nitromethylcellulose or derivatives thereof, for example, which increase the optical density, biocides such as Urarcide™, Proxel™ or NuoCept™, for example, buffer solutions for controlling the pH, compounds such as ethylenediaminetetraacetic acid for eliminating harmful effects of heavy-metal impurities, or organic solvents which are miscible with water, such as mono- and polyfunctional alcohols, amines, amides, heterocycles, sulfones, ureas, acetonitrile or acetone.

The invention also provides a process for preparing aqueous ink-jet ink compositions substantially containing
A) from 1% to 40% by weight of a dispersant composed of
   i) from 95% to 5% by weight of at least one block-copolymeric polyalkylene oxide containing styrene oxide, and
   ii) from 5% to 95% by weight of a ketone-aldehyde resin, and
   iii) from 0 to 80% by weight of at least one solvent, the sum of the amounts by weight of components i) to iii) being 100% by weight, and
B) from 1% to 70% by weight of at least one colorant, and
C) from 0 to 30% by weight of at least one auxiliary, and
D) from 10% to 98% by weight of water,

the amount of the sum of components A), B), C) and D) being 100% by weight,

by mixing components A), B), C), and D) at temperatures from 20 to 80° C. in a dissolver, Dispermat, Skandex mixer, Red Devil, single-roll mill, triple-roll mill, bead mill or other suitable assembly.

The ink-jet ink compositions of the invention are used for printing print media of all kinds. These include nontransparent print media such as simple papers, coated papers, glossy papers, and transparent print media such as transparent films, glossy films or films intended preferably for viewing in transmitted light, such as films for the printing of X-ray images, for example. The ink-jet ink compositions of the invention can be used in any conventional printer, piezoelectric printer or bubble-jet printer.

The invention hence also provides for the use of aqueous ink-jet ink compositions substantially containing
A) from 1% to 40% by weight of a dispersant composed of
   i) from 95% to 5% by weight of at least one block-copolymeric polyalkylene oxide containing styrene oxide, and
   ii) from 5% to 95% by weight of a ketone-aldehyde resin, and
   iii) from 0 to 80% by weight of at least one solvent, the sum of the amounts by weight of components i) to iii) being 100% by weight, and
B) from 1% to 70% by weight of at least one colorant, and
C) from 0 to 30% by weight of at least one auxiliary, and
D) from 10% to 98% by weight of water,

the amount of the sum of components A), B), C) and D) being 100% by weight, for printing transparent and nontransparent print media in conventional printers, piezoelectric printers or bubble-jet printers.

The ink-jet ink compositions of the invention are notable for outstanding water resistance and smearing resistance. Furthermore, the aqueous ink-jet ink compositions possess a high stability and the prints possess high gloss, high hardness, and excellent adhesion.

The examples which follow are intended to illustrate the invention but not to restrict its scope of application.

### EXAMPLES

### 1) Preparation of a Styrene Oxide-Containing Polyalkylene Oxide (Not Inventive)

336.4 g (2.34 mol) of trimethylcyclohexanol and 16.3 g (0.23 mol) of potassium methoxide were charged to a reactor. After careful flushing with pure nitrogen, the initial charge was heated to 110° C. and 308.2 g (2.554 mol) of styrene oxide were added over the course of an hour. After a further two hours the addition of the styrene oxide was at an end, as evidenced by a residual styrene oxide content of <0.1% by weight according to gas chromatogram. Subsequently 339.2 g (7.71 mol) of ethylene oxide were metered into the reactor at a rate such that the internal temperature did not exceed 120° C. and the pressure did not exceed 6 bar. Following complete introduction of the ethylene oxide, the temperature was held at 115° C. until a constant manometer pressure indicated the end of the subsequent reaction. Lastly, at to 90° C., the unreacted residual monomers were removed under reduced pressure. The product obtained was neutralized with the aid of phosphoric acid, followed by removal of the water by distillation and of the resultant potassium phosphate by filtration together with a filter aid. The molecular weight from the determination of the hydroxyl number, with an assumed functionality of 1, was M=467 g/mol.

### 2) Preparation of a Ketone-Aldehyde Resin (Not Inventive)

176.7 g of 4-tert-butylcyclohexanone, 481.7 g of 3,3,5-trimethylcyclohexanone, 112.4 g of cyclohexanone, and 373.1 g of a 30% strength by weight formaldehyde solution were introduced as an initial charge and heated to 60° C. Thereafter 114.5 g of a 50% strength by weight sodium hydroxide solution were added dropwise over the course of 15 minutes, after which the mixture was heated to 80° C. Subsequently, 200.0 g of the formaldehyde solution were added dropwise over the course of 90 minutes and the mixture was held at reflux at 85° C. for 4 hours. The resin obtained was washed to neutrality with water, following the addition of glacial acetic acid. Distillation gave a pale yellow, brittle resin having a softening point of 85° C.

### 3) Preparation of the Compound Having Binder Properties and Dispersing Properties from 1) and 2) (Not Inventive) 500 g of the styrene oxide-containing polyalkylene oxide from example 1) and 500 g of the ketone-aldehyde resin from example 2) were mixed with one another at 80° C. with stirring. The product was clear and had a viscosity at 23° C. of 88810 mPa s.

### 4) Preparation of an Ink-Jet Ink Composition (Inventive)

19.6 g of the compound having binder properties and dispersing properties from example 3) were mixed with 29.4 g of water. 2 g of Orasolgelb 3R (water-insoluble yellow dye from Ciba), 6 g of diethylene glycol and 43 g of water were added and the mixture was stirred.

### 5) Preparation of an Ink-Jet Ink (Comparative)

2 g of Orasolgelb were mixed with 6 g of diethylene glycol, 5 g of 4-bromophenylacetic acid and 87.5 g of water and the components were stirred together.

The water resistance was determined by applying drops of water to the dry prints. While the comparison ink showed slight water spots, the ink-jet ink composition of the invention was water-resistant. Moreover, when the print made with the ink-jet ink composition of the invention was marked using a marker pen, no smearing of the ink was apparent.

1. An aqueous ink-jet ink composition, comprising
A) from 1% to 40% by weight of a dispersant composed of
i) from 95% to 5% by weight of at least one block-copolymeric polyalkylene oxide containing styrene oxide,
ii) from 5% to 95% by weight of a ketone-aldehyde resin, and
iii) from 0 to 80% by weight of at least one solvent,
wherein the sum of the amounts by weight of components i) to iii) being 100% by weight,
B) from 1% to 70% by weight of at least one colorant,
C) from 0 to 30% by weight of at least one auxiliary, and
D) from 10% to 98% by weight of water,
wherein the amount of the sum of components A), B), C) and D) being 100% by weight.

2. The ink composition according to claim 1, wherein the block-copolymeric polyalkylene oxides i) comprising styrene oxide in component A) is represented by the following formula:
R¹O(SO)ₐ(EO)_{b}(PO)_{c}(BO)_{d}R²,
where R¹ is a straight-chain or branched or cycloaliphatic radical having from 8 to 13 carbon atoms,
R=hydrogen, an aryl radical, alkyl radical or carboxylic acid radical having in each case from 1 to 8 carbon atoms,
SO=styrene oxide,
EO=ethylene oxide,
PO=propylene oxide,
BO=butylene oxide and
a=1 to 1.9,
b=3 to 50,
c=0 to 3,
d=0 to 3,
a, c or d being other than 0, and b>=a+c+d.

3. The ink composition according to claim 1, wherein the ketone-aldehyde resins ii) in component A) contain comprise
I. from 40% to 100 mol %, based on all ketones employed, of at least one alkyl-substituted cyclohexanone with one or more alkyl radicals having from 1 to 8 carbon atoms,
II. from 0.8 to 2.0 mol of at least one aliphatic aldehyde, based on 1 mol of all the ketones employed, and
III. from 0 to 60 mol %, based on all ketones employed, of further ketones having aliphatic, cycloaliphatic, aromatic hydrocarbon radicals, the radicals may be identical or different and, optionally, substituted by the hydrocarbon radicals in a hydrocarbon chain, and, optionally, phenols and/or urea or derivatives thereof.

4. The ink composition according to claim 1, wherein pigments or dyes are present as component B).

5. The ink composition according to claim 1, wherein organic and/or inorganic pigments and/or carbon blacks are present as component B).

6. The ink composition according to claim 1, wherein titanium dioxides or iron oxides are present as component B.

7. The ink composition according to claim 1, wherein compound B is at least one selected from the group consisting of azo pigments, metal complex pigments, anthraquinonoid pigments, phthalocyanine pigments, and polycyclic pigments.

8. The ink composition according to claim 1, wherein gas blacks, lamp blacks or furnace blacks are used as component B).

9. The ink composition according to claim 1, wherein natural or synthetic dyes are used as component B).

10. The ink composition according to claim 1, wherein animal dyes or vegetable dyes are used as component B).

11. The ink composition according to claim 1, wherein compound B is at least one selected from the group consisting of carmine, kermes, lac dyes, Indian yellow, purple, sepia, gallstone, indigo, alizarin dyes, flavonol dyes, dyes of the brasilin group, dragon's blood and gamboge.

12. The ink composition according to claim 1 wherein compound B is at least one selected from the group consisting of basic dyes and color bases, acidic dyes and water-soluble metal complex dyes, alcohol- and ester-soluble dyes and oil- and fat-soluble dyes.

13. The ink composition according to claim 1, wherein fillers of up to 95% by weight, based on the colorant, are additionally used as component B).

14. The ink composition according to claim 1, wherein defoamers are used as component C).

15. The ink composition according to claim 1, wherein devolatilizers are used as component C).

16. The ink composition according to claim 1, wherein rheological assistants are used as component C).

17. The ink composition according to claim 1, wherein surface additives are used as component C).

18. The ink composition according to claim 1, wherein substrate wetting additives are used as component C).

19. The ink composition according to claim 1, wherein colloids are used as component C).

20. The ink composition according to claim 1, wherein biocides are used as component C).

21. The ink composition according to claim 1, wherein buffer solutions are used as component C).

22. The ink composition according to claim 1, wherein complexing agents are used as component C).

23. The ink composition according to claim 1, wherein water-miscible organic solvents are used as component C).

24. The ink composition according to claim 1, wherein compound C is at least one selected from the group consisting of that mono- or polyfunctional alcohols, amines, amides, heterocycles, sulfolles, ureas, acetonitrile and acetone.

25. A process for preparing an aqueous ink-jet ink composition comprising:
mixing compounds A), B), C), and D) at temperatures from 20 to 80° C. in a dissolver, Dispermat, Skandex mixer, Red Devil, single-roll mill, triple-roll mill or bead mill, wherein the composition comprises:
A) from 1% to 40% by weight of a dispersant comprising
i) from 95% to 5% by weight of at least one block-copolymeric polyalkylene oxide containing styrene oxide,
ii) from 5% to 95% by weight of a ketone-aldehyde resin,
iii) from 0 to 80% by weight of at least one solvent, wherein the sum of the amounts by weight of components i) to iii) being 100% by weight,
B) from 1% to 70% by weight of at least one colorant,
C) from 0 to 30% by weight of at least one auxiliary, and
D) from 10% to 98% by weight of water,
wherein the amount of the sum of components A), B), C) and D) being 100% by weight.

26. (canceled)
